(19) United States
(12) Patent Application Publication
(10) Pub. No.: US 2008/0048630 A1
(43) Pub. Date: Feb. 28, 2008

(54) Switching power supply circuit

(75) Inventor: Hideyuki Imanaka, Tenri-shi (JP)

Correspondence Address: HARNESS, DICKEY & PIERCE, P.L.C., P.O. BOX 8910, RESTON, VA, 20195, US

(73) Assignee: SHARP KABUSHIKI KAISHA

(21) Appl. No.: 11/878,825

(22) Filed: Jul. 27, 2007

(30) Foreign Application Priority Data
Jul. 28, 2006 (JP) 2006-205648

(51) Int. Cl. G05F 1/56

(52) U.S. Cl. 323/282

(57) ABSTRACT

A trigger-type signal Ve having the same period as that of a reference pulse signal Vp outputted from a reference pulse generation circuit is inputted to a set terminal of a logic circuit and a signal Vg having a polarity opposite to that of the signal Ve is inputted to a sample hold circuit. When a rise of the signal Ve is detected, a switching element S1 becomes on-state and a switching element S2 becomes off-state at the same time. Thus, a voltage based on a current flowing in the switching element S1 is not applied to an addition circuit but a voltage charged in a capacitor just before is applied thereto. After a time based on a pulse width of the signal Ve has passed, when the signal Vg rises and the switching element S2 becomes on-state, the voltage based on the current is applied to the addition circuit.

### CROSS REFERENCE TO RELATED APPLICATION

This Nonprovisional application claims priority under 35 U.S.C. §119(a) on Patent Application No. 2006-205648 filed in Japan on 28 Jul. 2006 the entire contents of which are hereby incorporated by reference.

### BACKGROUND OF THE INVENTION

1. Field of the Invention

The present invention relates to a switching power supply circuit to output a predetermined DC voltage by turning on and off a switching element based on an inputted switching control signal.

2. Description of the Related Art

As one of power supply circuits to output a DC voltage having a predetermined voltage value, a switching power supply circuit that converts a DC voltage inputted by on-off control of a switching element into a predetermined voltage value and outputs it is conventionally used as a constant voltage source.

FIG. 5 is a circuit block diagram showing one example of the schematic constitution of a conventional switching power supply circuit. A switching power supply circuit 90 shown in FIG. 5 includes a reference pulse generation circuit 2, a DC-DC converter 4, a switching control signal generation circuit 91, and a current detection circuit 92.

The reference pulse generation circuit 2 generates a pulse signal having a predetermined frequency (referred to as the reference pulse signal hereinafter) and applies the generated reference pulse signal to the switching control signal generation circuit 91.

The DC-DC converter 4 includes a DC voltage source E1 (voltage V_{IN}), inductor L1, a diode D1, a switching element S1, and a capacitor C1. That is, as shown in FIG. 5, one terminal p1 of the inductor L1 is connected to a positive voltage side of the DC voltage source E1 and the other end p2 thereof is connected to an anode electrode pa of the diode D1 and one terminal pd of the switching element S1. A description will be made hereinafter assuming that the switching element S1 includes an N channel MOSFET. In this case, the switching element S1 includes a drain electrode pd, a source electrode ps, and a gate electrode pg.

In addition, one electrode p3 of the capacitor C1 is connected to a cathode electrode pk of the diode D1 and the other electrode p4 of the capacitor C1 is connected to the minus voltage side of the DC voltage source E1. Thus, the voltage at both ends of the capacitor C1 is used for a circuit and the like at the subsequent stage as an output voltage V_{OUT}.

The switching element S1 is turned on or off when a switching control signal Vq is applied from the switching control signal generation circuit 91 to the gate electrode pg and when it is in on-state, a current I_{S1} flows through the switching element S1. In order to detect this current I_{S1}, the source electrode ps and the current detection circuit 92 are connected. In addition, the current flowing through the switching element S1 is referred to as the detection current hereinafter.

The current detection circuit 92 converts the detection current I_{S1} to a voltage V1 by a resistor R1 and outputs the voltage V1 to the switching control signal generation circuit 91. In addition, a feedback input voltage V_{FB} obtained such that the output voltage V_{OUT} is resistively divided is also inputted to the switching control signal generation circuit 91. The switching control signal Vq is generated based on the voltage V1 based on the detection current I_{S1} and the feedback input voltage V_{FB}.

The switching control signal generation circuit 91 includes a triangular wave generation circuit 15, a differential amplification circuit 16, a comparison circuit 17, a duty ration adjustment circuit 95, a logic circuit 14, an addition circuit 18 and a DC voltage source E2 in which a reference voltage V_{REF} is set.

The triangular wave generation circuit 15 generates a triangular wave or a saw wave in synchronization with the reference pulse signal outputted from the reference pulse generation circuit 2 and outputs it to the addition circuit 18 (the above wave is referred to as the triangular wave containing the saw wave). The addition circuit 18 combines the voltage signal V1 outputted from the current detection circuit 92 and a triangular wave output signal Vd outputted from the triangular wave generation circuit 15 and applies a combined output voltage V2 to the comparison circuit 17.

The differential amplification circuit 16 receives the DC voltage V_{REF} set as a predetermined reference voltage value and the feedback input voltage V_{FB} and generates a signal V0 by amplifying the voltage difference between them and outputs it to the comparison circuit 17. The comparison circuit 17 compares the output signal V2 of the addition circuit 18 with an output signal V0 from the differential amplification circuit 16 and inputs a signal Va in which a compared result is shown in binary level, to a reset terminal R that is one input terminal of the logic circuit 14.

The duty ratio adjustment circuit 95 adjusts the duty ratio of a reference pulse signal Vp outputted from the reference pulse generation circuit 2 and inputs an adjusted signal (referred to as a duty ratio adjusted signal occasionally hereinafter) Vr to the other input terminal of the logic circuit 14, that is, a set terminal S. Then, an output signal Vq determined in accordance with the level states of the signals inputted to the reset terminal R and the set terminal S is applied to the gate electrode pg of the switching element S1 as a switching control signal.

The logic circuit 14 has a two-terminals such as the set terminal S and the reset terminal R as input terminals and outputs the output signal according to the following logic contents based on the level of the input signal. That is, the logic circuit 14 is so constituted that when the signal inputted to the reset terminal R (referred to as the reset signal hereinafter) is at high level, outputs a low level output signal regardless of the signal level of the signal inputted to the set terminal (referred to as the set signal hereinafter), and when the set signal is at high level under the condition that the reset signal is at low level, the logic circuit 14 outputs a high level output signal. The logic circuit 14 can be a reset signal priority type of RS flip-flop circuit (the logic circuit 14 is referred to as the RS flip-flop circuit 14 occasionally hereinafter).

In this constitution, when the duty ratio adjusted signal Vr inputted to the set terminal S rises to high level under the condition that the output signal Va from the comparison circuit 17 inputted to the reset terminal R is at low level, in response to this rise, the switching control signal Vq rises to high level and then when the output signal Va rises, in response to this, the switching control signal Vq falls to low level. That is, when a value of the signal V2 exceeds a value of the signal V0, the signal Va rises and in response to this, the switching control signal Vq falls. Thus, the duty ratio of the switching control signal Vq can be controlled by the compared result between the signal V2 and the signal V0. As described above, in the case where the switching element S1 is the N channel MOSFET, when the switching control signal Vq is at high level, the switching element S1 is in on-state and when the switching control signal Vq is at low level, the switching element S1 is in off-state. In other words, the on-off control of the switching element S1 is performed depending on the compared result between the signal V2 and the signal V0. Especially, since the value of the signal V2 depends on the detection current I_{S1}, it can be said that the switching element S1 is turned on or off based on a value of the detection current I_{S1} flowing in the switching element S1.

FIG. 6 is one example of a timing chart showing each voltage signal in the switching power supply circuit 90 having the constitution shown in FIG. 5. FIG. 6(a) shows a voltage value of the reference pulse signal Vp, FIG. 6(b) shows a voltage value of the output signal Vr of the duty ratio adjustment circuit 95, FIG. 6(c) shows a voltage value of the triangular wave output signal Vd, FIG. 6(d) shows voltage values of the output signal V1 of the current detection circuit 92 and the output signal V2 of the addition circuit 18, FIG. 6(e) shows a voltage value of the output signal Va of the comparison circuit 17, and FIG. 6(f) shows a voltage value of the switching control signal Vq.

The duty ratio adjustment circuit 95 adjusts the duty ratio of the reference pulse signal Vp shown in FIG. 6(a) and outputs the duty ratio adjusted signal Vr as shown in FIG. 6(b). In addition, the triangular generation circuit 15 generates the triangular signal Vd as shown in FIG. 6(c) in synchronization with the reference pulse signal Vp.

Since the duty ratio adjusted signal Vr rises at a time t0, the RS flip-flop circuit 14 is set and the switching control signal Vq rises (refer to FIG. 6(f)), so that the switching element S1 is turned on. When the switching element S1 becomes on-state, the DC voltage source V_{IN}, the inductor L1, and the switching element S1 constitute a closed circuit α1 (not shown in the drawing for simplicity), whereby the predetermined DC current I_{S1} flows in the switching element S1. In addition, since the voltage at both ends of the inductor L1 is maintained at a constant value by the DC voltage source V_{IN} in the closed circuit α1, the current value flowing in the inductor L1, that is, the detection current I_{S1} flowing in the switching element S1 is increased with the time. Namely, the voltage V1 based on the detection current I_{S1} rises (refer to FIG. 6(d)).

In addition, since the triangular wave signal Vd also rises after the time t0, the signal V2 that is a sum of the signal Vd and signal V1 also rises. Thus, when a value of this signal V2 exceeds the output signal V0 of the differential amplification circuit 16 (at time t11), the signal Va that is the compared result of the comparison circuit 17 rises (refer to FIG. 6(e)) and the reset is inputted to RS flip-flop circuit 14. Thus, the switching control signal Vq falls (refer to FIG. 6(f), the switching element S1 is turned off.

When the switching element S1 becomes off-state at the time t11, since the detection current I_{S1} flowing in the switching element S1 is not detected, the output voltage V1 of the current detection circuit 92 becomes an initial state (zero, for example). Accordingly, the value of the signal V2 also is fallen and when the value of the signal V2 becomes below the value of the signal V0, the signal Va falls (at a time t12). At this time, the reset input is canceled. Thus, the switching element S1 keeps in off-state until the duty ratio adjusted signal Vr rises again (time t1).

When the duty ratio adjusted signal Vr rises to high level at the time t1, since the RS flop-flop circuit 14 is set, the switching control signal Vq rises (refer to FIG. 6(f)), so that the switching element S1 is turned on and the voltage V2 starts to rise again. Thereafter, this cycle is repeated to turn on and off the switching element S1.

However, since the switching element S1 includes the transistor element such as the MOSFET as described above, when the switching element S1 is switched from off-state to on-state, a noise current may be generated due to the discharge current of parasitic capacity of the transistor and a recovery current of a parasitic diode in some cases, and the voltage V1 converted based on this noise current may exceed the voltage V0 to be compared in some cases.

FIG. 7 is one example of a timing chart showing each voltage signal in the case where the noise current is generated as describe above, in which FIG. 7(a) to 7(f) correspond to FIG. 6(a) to 6(f), respectively. When the switching element S1 becomes on-state at the time t0, the voltage V1 exceeds the voltage V0 because the noise current is superposed on the detection current I_{S1} flowing in the switching element S1, so that the voltage V2 that is the sum of the voltage 1 and the triangular signal output Vd also exceeds the voltage V0. When it is confirmed that the voltage V2 exceeds the voltage V0 by the comparison circuit 17 (time t21), the signal Va rises accordingly (refer to FIG. 7(e)), and the reset is inputted to the RS flip-flop circuit 14, and the switching control signal Vq rises at the same time (refer to FIG. 7(f)). In short, the switching element S1 becomes off-state at the time t21.

Thereafter, since the duty ratio adjusted signal Vr is at high level, a high level signal is inputted to the set terminal S of the RS flip-flop circuit 14 again and the switching control signal Vq rises again (time t25), and the switching element S1 becomes on-state at the same time. Then, after the time t25, similar to FIG. 6 described above, the voltage V2 rises with the time and when the voltage V2 exceeds the output signal V0 of the differential amplification circuit 16 (time t22), the Va that is the compared result of the comparison circuit 17 rises (refer to FIG. 7(e)), and the reset is inputted to the RS flip-flop circuit 14. Thus, the switching control signal Vq falls (refer to FIG. 7(f)), and the switching element S1 becomes off-state.

That is, when the voltage detection circuit 92 detects the noise current generated when the switching element S1 switches from off-state to on-state, the switching control signal Vq falls in response to the noise current. As a result, a desired duty cannot be provided, which causes the switching element S1 to malfunction.

In order to solve the above problem, a constitution in which a mask circuit for masking the voltage signal based on the noise current generated from the switching element S1 for a certain period of time is provided has been conventionally disclosed (refer to Japanese Unexamined Patent Publication No. 2006-87157, for example). This conventional circuit constitution will be described with reference to the drawings hereinafter.

FIG. 8 is a circuit block diagram in which a mask circuit disclosed in Japanese Unexamined Patent Publication No. 2006-87157 is applied to the switching power supply circuit shown in FIG. 5.

A switching power supply circuit 90a shown in FIG. 8 further includes a mask circuit 93 in addition to the switching power supply circuit 90 shown in FIG. 5. The mask circuit 93 includes a NOT circuit 96 and an AND circuit 94, in which a duty ratio adjusted signal Vr from a duty ratio adjustment circuit 95 is inputted to the NOT circuit 96, an output signal Vw of the NOT circuit 96 and an output signal Va of a comparison circuit 17 are inputted to the AND circuit 94, and an output signal Vh of the AND circuit 94 is inputted to a reset terminal R of the RS flip-flop circuit 14.

FIG. 9 is one example of a timing chart showing each voltage signal in the switching power supply circuit 90a having the constitution shown in FIG. 8. FIG. 9(a) shows a voltage value of a reference pulse signal Vp, FIG. 9(b) shows a voltage value of the duty ratio adjusted signal Vr, FIG. 9(c) shows a voltage value of the output signal Vw of the NOT circuit 96, FIG. 9(d) shows a voltage value of a triangular wave output signal Vd, FIG. 9(e) shows voltage values of an output signal V1 of a current detection circuit 92 and an output signal V2 of an addition circuit 18, FIG. 9(f) shows a voltage value of an output signal Va of the comparison circuit 17, FIG. 9(g) shows a voltage value of the output signal Vh of the AND circuit 94 and FIG. 9(h) shows a voltage value of a switching control signal Vq.

Similar to the case described with reference to the timing chart in FIG. 7, when the switching element S1 is switched from off-state to on-state, a noise current is generated (at a time t21, for example) and the voltage V1 and the voltage V2 exceed the voltage V0 accordingly (refer to FIG. 9(e)), and the output signal Va of the comparison circuit 17 rises to high level. Meanwhile, since the duty ratio adjusted signal Vr is at high level at that time (time t21), the output signal Vw outputted from the NOT circuit 96 to which the signal Vr was inputted is at low level. Therefore, since the output signal Vh from the AND circuit 94 to which the signal Va and the signal Vw were inputted is kept at low level (refer to FIG. 9(g)), the reset is not inputted at the time t21 in the constitution in FIG. 8 in which the output signal Vh is inputted to the reset terminal R, so that the switching element S1 is not switched to off-state at the same time (as shown in FIG. 9(h), the switching control signal Vq is kept at high level at the time 21).

More specifically, according to the constitution in FIG. 8, while the duty ratio adjusted signal Vr generated from the duty ratio adjustment circuit 95 is at high level, since a high level signal Vh is not inputted to the reset terminal R, the noise current generated when the switching element S1 is switched from off-state to on-state can be masked.

However, according to the constitution shown in FIG. 8, due to an affect of a wiring length connecting the switching element S1 to the comparison circuit 17 and the like, after the noise current has been generated just after the switching element S1 is turned on actually, it takes a predetermined time until the voltage caused by the noise current is inputted to the comparison circuit 17 as a comparison object. Thus, there is a case where a masking function does not work depending on the pulse width of the duty ratio adjusted signal Vr outputted from the duty ratio adjustment circuit 95 in some cases.

FIG. 10 is one example of a timing chart showing each voltage signal in the case where the mask function does not work in the switching power supply circuit 90a shown in FIG. 8, and FIG. 10(a) to 10(h) correspond to FIG. 9(a) to 9(h), respectively.

The duty ratio adjustment circuit 95 generates the duty ratio adjusted signal Vr having a pulse width of da (refer to FIG. 10(b)). That is, similar to the reference pulse signal Vp, the duty ratio adjusted signal Vr rises at the time t0, and then falls after the time da has passed and its low level is kept until the reference pulse signal Vp rises at the time t1 again. Namely, the output signal Vw of the NOT circuit 96 to which the signal Vr was inputted is kept at low level from the time t0 until after the time da has passed and then rises to high level and it shows a waveform in which high level is kept until the time t1 (refer to FIG. 10(c)).

As described above, since it takes the predetermined time after the switching element S1 has become on-state until after the voltage V2 based on the noise current (strictly speaking, the total voltage of the voltage V1 based on the noise current and the triangular wave signal output Vd) is inputted to the comparison circuit 17, the predetermined time could exceed the pulse width da of the duty ratio adjusted signal Vr. In this case, when the voltage V2 based on the noise current exceeds the voltage V0 (at the time t31 in FIG. 10(e)), since the output signal Vw of the NOT circuit 96 is at high level (refer to FIG. 10(c)), the signal Vh outputted from the AND circuit 94 is at high level (refer to FIG. 10(g)), so that the RS flip-flop circuit 14 is reset. More specifically, the switching control signal Vq falls at the time t31 (refer to FIG. 10(h)), and the switching element S1 is switched to off-state at this time, which means that malfunction such that the switching element S1 is switched to off-state due to the noise current generated when the switching element S1 switches to on-state is generated and the masking function of the mask circuit 93 in FIG. 8 does not effectively work.

Therefore, in order to allow the mask circuit 93 shown in FIG. 8 to function effectively, the pulse width of the duty ratio adjusted signal Vr has to be set to be longer than the time required after the switching element S1 has been turned on until the voltage caused by the noise current is inputted to the comparison circuit 17 as a comparison target.

FIG. 11 is one example of a timing chart showing each voltage signal when the pulse width of the duty ratio adjusted signal Vr is set so that the masking function may work, in which FIG. 11(a) to 11(h) correspond to FIG. 9(a) to 9(h), respectively.

As shown in FIG. 11(b), when a pulse width da2 of the duty ratio adjusted signal Vr is previously set so as to be longer than the pulse width da in FIG. 10(b) in the duty ratio adjustment circuit 95, the duty ratio adjusted signal Vr is at high level even at a time t31 when the voltage V2 based on the noise current is inputted to the comparison circuit 17, so that the output signal Vw of the NOT circuit 96 is at low level. More specifically, since a low level signal Vw is inputted to the AND circuit 94 at the time t31, a low level signal Vh is outputted from the AND circuit 94 at that time (refer to FIG. 11(g)), so that the RS flip-flop circuit 14 is not reset at the time t31. That is, since the switching element S1 is still in on-state after the time t31, the malfunction of the switching element S1 due to the noise current can be prevented. In addition, after the time t31, similar to the above described with reference to FIGS. 6 and 7, the voltage V2 rises due to a rise of the detection current I_{S1} and when this voltage V2 exceeds the voltage V0 (at a time t 41 in FIG. 11(e)), the signal Va rises.

At this time, when it is assumed that the pulse width da2 of the duty ratio adjusted signal Vr is previously set so as to be longer than the time from the time t0 to the time t31 and so as to be shorter than the time from the time t0 to the time t41, while the duty ratio adjusted signal Vr has already been switched to low level at the time t41 (refer to FIG. 11(b)), the negation signal Vw of the NOT circuit 96 has been already switched to high level at the time t41 (refer to FIG. 11(c)). Therefore, since a high level signal Va and a high level signal Vw are inputted to the AND circuit 94 at the time t41, the AND circuit 94 outputs a high level signal Vh (refer to FIG. 11(g)) to the reset terminal R. Thus, the RS flip-flop circuit 14 is reset at the time t41 and the switching control signal Vq falls, so that the switching element S1 switches to off-state. More specifically, the switching element S1 can be controlled without being affected by the noise current, by setting the pulse width of the duty ratio adjusted signal Vr to be the predetermined value.

Therefore, in other words, in order to control the switching element S1 without the effect of the noise current in the constitution shown in FIG. 8, it is necessary to set the pulse width of the duty ratio adjusted signal Vr generated in the duty ratio adjustment circuit 95 to be a desired value. However, as described above, since the time from when the switching element S1 is turned on until when the voltage based on the noise current is inputted to the comparison circuit 17 mainly depends on the wiring length, its value could vary with respect to each switching power supply circuit 90a, and it is necessary to set the pulse width of the signal Vr generated by the duty ratio adjustment circuit 95 with respect to each circuit in some cases. In addition, when a control circuit is separately provided to automatically set the pulse width in each circuit, the problem is that the internal structure becomes complicated and the circuit size is increased.

### SUMMARY OF THE INVENTION

It is an object of the present invention to provide a switching power supply circuit that can output a desired DC voltage by appropriately performing on/off control for a switching element in accordance with a current value flowing in the switching element.

A switching power supply circuit according to the present invention to attain the above object outputs a predetermined DC voltage by controlling on/off of a switching element based on an inputted switching control signal, and the switching power supply circuit is firstly characterized by comprising a reference pulse generation circuit for generating a reference pulse signal having a predetermined period, a current detection circuit for detecting a current flowing in the switching element and outputting an output signal based on a detected detection current value, a switching control signal generation circuit for generating the switching control signal based on a signal varying depending on the output signal of the current detection circuit and the reference pulse signal, and a timing signal generation circuit for generating a timing signal switching from a first state to a second state in its signal state in response to a rise of the reference pulse signal and switching from the second state to the first state after the second state is maintained during a predetermined first period, wherein the current detection circuit receives the timing signal and applies a predetermined output unrelated to the detection current value detected actually during the first period, to the switching control signal generation circuit during the first period.

According to the first characteristic constitution of the switching power supply circuit in the present invention, since the predetermined output unrelated to the detection current value is applied to the switching control signal generation circuit from the rise of the reference pulse signal until after the predetermined first period, the switching control signal is generated based on this predetermined output during the first period. Therefore, even when a noise current is generated in the switching element because the switching element switches from off-state to on-state due to the rise of the reference pulse signal, since the predetermined output unrelated to the noise current value is outputted to the switching control signal generation circuit from the rise of the reference pulse signal until after the predetermined first period, the switching control signal generated by the switching power supply circuit is not affected by the noise current. More specifically, even when a sufficiently large noise current is generated just after the switching element is turned on, since the switching control signal causing the switching element to switch to off-state based on the noise current only is not generated, the switching element can be controlled without being affected by the noise current.

Furthermore, since the current detection circuit applies the predetermined output unrelated to the detection current value, to the switching control signal generation circuit for the predetermined first period determined by the timing signal directly inputted to the current detection circuit, the voltage based on the current flowing in the switching element is not inputted to the switching control signal generation circuit during the above period. That is, as compared with the case where the masking process is performed in the switching control signal generation circuit for the detection current during the predetermined period after the switching element has been turned on so as not to be affected by the noise current, it is not necessary to consider the time required for an electric signal to reach a circuit for the masking process after the switching element has been turned on (the time depends on the wiring length). When considering the time depending on the wiring length, since that time could vary in each switching power supply circuit, it is necessary to set the time for the masking process with respect to each circuit and a control circuit for that setting is needed separately in some cases. Meanwhile, according to the constitution of the present invention, since such control circuit is not needed, the circuit size can be miniaturized.

Furthermore, according to the switching power supply circuit of the present invention, in addition to the first characteristic constitution, it is secondly characterized in that the current detection circuit is configured to comprise a sample hold circuit that can hold a signal based on the detection current value temporally, and apply an output signal to the switching control signal generation circuit through the sample hold circuit. The current detection circuit outputs a signal based on the detection current value to the switching control signal generation circuit during a second period in which the signal state of the timing signal is in the first state, and outputs a held signal based on the detection current value in the second period just before the first period, to the switching control signal generation circuit during the first period.

According to a second characteristic constitution of the switching power supply circuit of the present invention, the signal based on the detection current value during the second period just before the rise point of the reference pulse signal, in which the timing signal is in the first state, is applied to the switching control signal generation circuit from the rise point of the reference pulse signal until after the first period. That is, when the noise current is generated in the switching element because the switching element switches from off-state to on-state in response to the rise of the reference pulse signal, the signal based on the detection current value at the timing in the second period just before, that is, just before the reference pulse signal rises is applied to the current detection circuit. Namely, when the switching element switches from off-state to on-state in response to the rise of the reference pulse signal, since the switching element is in off-state at the timing just before the reference pulse signal rises, the detection current value when the switching element is in off-state is applied to the switching control signal generation circuit and the switching control signal is generated based on this value, so that the switching control signal is not generated based on the noise current, whereby the switching element can be appropriately controlled.

In addition, according to the switching power supply circuit of the present invention, in addition to the first or second characteristics, it is thirdly characterized in that the switching control signal generation circuit comprises a comparison circuit for comparing a target signal varying depending on the output signal of the current detection circuit with a reference signal inputted from the outside and outputting its compared result, and generates the switching control signal which turns on the switching element when the switching element is in off-state at the rise of the reference pulse signal and turns off the switching element when the comparison circuit outputs the compared result that the target signal exceeds the reference signal.

According to a third characteristic constitution of the switching power supply circuit of the present invention, the switching control can be performed based on the amount of the detection current value flowing in the switching element.

According to the switching power supply circuit of the present invention, in addition to the third characteristics, it is forth characterized in that the switching control signal generation circuit comprises a logic circuit having two input terminals consisting of a set terminal and a reset terminal and an output terminal for outputting a low level signal from the output terminal regardless of the level of a signal inputted to the set terminal when a signal inputted to the reset terminal is at high level, and outputting a high level signal from the output terminal when the signal inputted to the reset terminal is at low level and the signal inputted to the set terminal is at high level. The logic circuit receives the reference pulse signal or a pulse signal having the same period as that of the reference pulse signal generated based on the reference pulse signal inputted to the set terminal, a signal based on the compared result inputted to the reset terminal and outputs the switching control signal from the output terminal.

According to a fourth characteristic constitution of the switching power supply circuit, although a high level signal is outputted from the output terminal in response to the rise of the reference pulse signal and accordingly the switching element switches to on-state, since the predetermined output unrelated to the detection current value flowing in the switching element is applied to the comparison circuit from the rise of the reference pulse signal until after the predetermined first period, a low level signal is outputted from the comparison circuit by setting the predetermined output to be lower than the reference signal, so that the high level signal is not inputted to the reset terminal of the logic circuit at this time and thus, the low level signal is not outputted from the output terminal of the logic circuit. Namely, the malfunction in which the switching element switches to off-state based on the noise current generated when the switching element switches from off-state to on-state can be prevented.

Furthermore, according to the switching power supply circuit of the present invention, in addition to the fourth characteristic constitution, it is fifth characterized in that the switching control signal generation circuit comprises a NOT circuit for receiving the reference pulse signal, a delay circuit for receiving the output signal of the NOT circuit, and an AND circuit for receiving the output signal of the delay circuit and the reference pulse signal, wherein the output signal of the AND circuit is inputted to the set terminal.

According to a fifth characteristic constitution of the switching power supply circuit of the present invention, the pulse width of the signal outputted from the AND circuit can be set based on the delay time set by the delay circuit. Therefore, after the switching element has switched from off-state to on-state, when the delay time is set according to the increasing speed of the current flowing in the switching element, the high level signal is not inputted to the set terminal just after the high level signal is inputted to the reset terminal because the target signal exceeds the reference signal. That is, according to the above constitution, after the switching element has switched from on-state to off-state, the off-state can be kept for a predetermined time.

In addition, according to the switching power supply circuit of the present invention, in addition to the fifth characteristic constitution, it is sixth characterized in that the switching control signal generation circuit comprises an OR circuit receiving the output signal of the NOT circuit and a signal based on the compared result, wherein the output signal of the OR circuit is inputted to the reset terminal.

According to a sixth characteristic constitution of the switching power supply circuit of the present invention, since the high level signal is inputted to the reset terminal when the reference pulse signal becomes low level and accordingly the low level signal is outputted from the output terminal, so that the switching element becomes off-state. Thus, even when the target signal does not exceed the reference signal because the reference signal is previously set to a high value, the switching element is forcibly turned on/off, so that an overcurrent is prevented from flowing in the switching element.

Furthermore, according to the switching power supply circuit of the present invention, in addition to any one of the third to sixth characteristic constitutions, it is seventh characterized in that the switching control signal generation circuit comprises a differential amplification circuit for amplifying the difference between a feedback input voltage based on the outputted DC voltage and a target voltage, and a triangular wave generation circuit for generating a triangular wave or a saw wave in synchronization with the reference pulse signal and outputting it, wherein the comparison circuit compares the target signal comprising a combined signal of the output signal of the triangular wave generation circuit and the output signal of the current detection circuit, with the reference signal comprising the output signal of the differential amplification circuit and outputs its compared result.

According to a seventh characteristic constitution of the switching power supply circuit of the present invention, the control for bringing the feedback input voltage close to the predetermined target voltage can be performed automatically, whereby the voltage outputted from the switching power supply circuit can be kept at a desired value.

According to the switching power supply circuit of the present invention, since the predetermined output unrelated to the detection current value is applied to the switching control signal generation circuit from the rise of the reference pulse signal until after the predetermined first period, the switching control signal is generated based on the predetermined output during the first period. Therefore, even when the noise current is generated in the switching element because the switching element switches from off-state to on-state in response to the rise of the reference pulse signal, since the predetermined output unrelated to the noise current value is outputted to the switching control signal generation circuit from the rise of the reference pulse signal until after the predetermined first period, the switching control signal generated by the switching control signal generation circuit is not affected by the noise current. That is, even when a sufficiently large noise current is generated just after the switching element has been turned on, since the switching control signal in response to which the switching element switches to off-state based on the noise current only is not generated, the switching element can be controlled without being affected by the noise current.

### BRIEF DESCRIPTION OF THE DRAWINGS

FIG. 1 is a circuit block diagram showing a schematic constitution of a switching power supply circuit according to the present invention;

FIG. 2 is a timing chart showing each voltage signal in the switching power supply circuit having the constitution shown in FIG. 1;

FIG. 3 is a timing chart showing each voltage signal in the switching power supply circuit having the constitution shown in FIG. 1;

FIG. 4 is another circuit block diagram showing the schematic constitution of the switching power supply circuit according to the present invention;

FIG. 5 is a circuit block diagram showing a schematic constitution of a conventional switching power supply circuit;

FIG. 6 is an example of a timing chart showing each voltage signal in the switching power supply circuit having the constitution shown in FIG. 5;

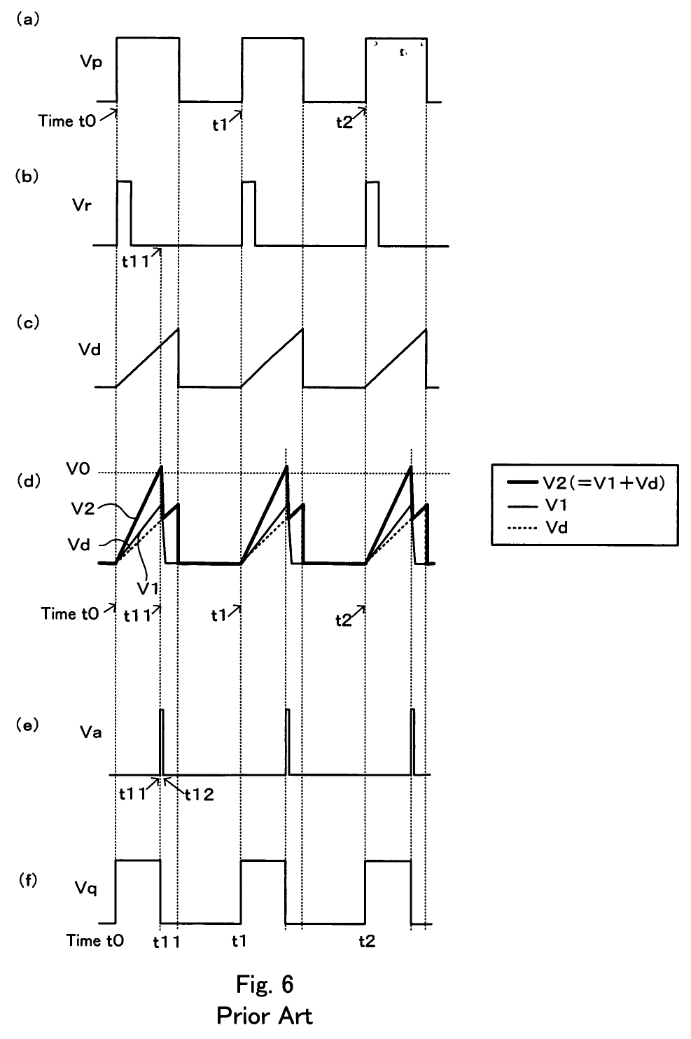

FIG. 7 is an example of a timing chart showing each voltage signal in the switching power supply circuit having the constitution shown in FIG. 5 when a noise current is generated;

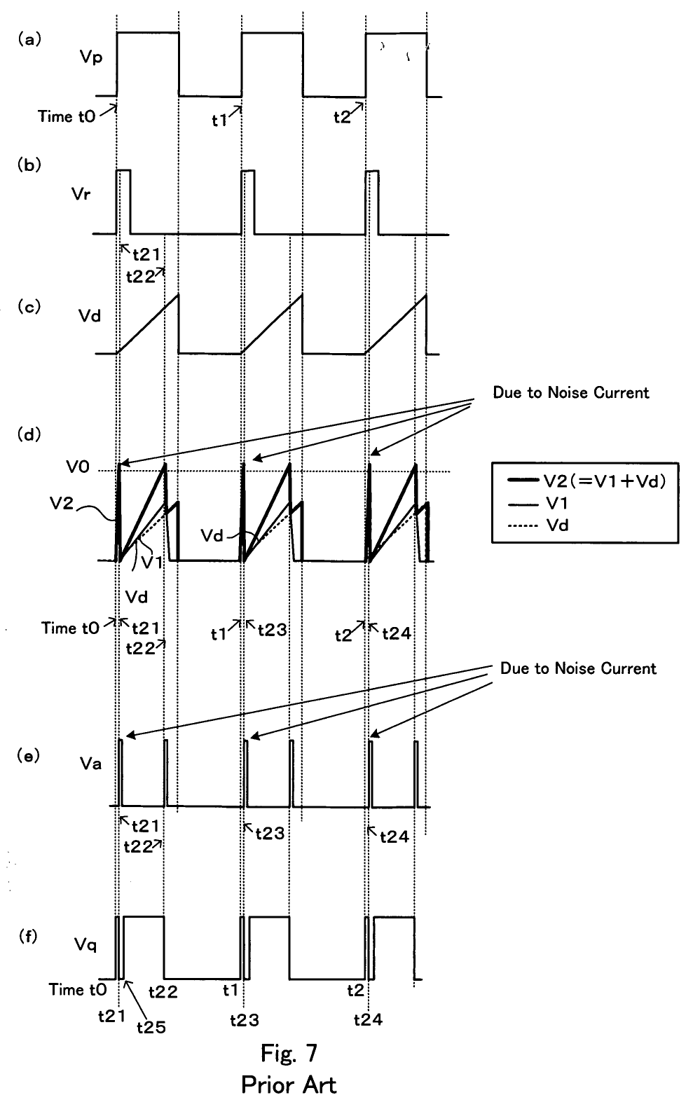

FIG. 8 is a circuit block diagram showing the schematic constitution of a conventional switching power supply circuit comprising a mask circuit;

FIG. 9 is an example of a timing chart showing each voltage signal in the switching power supply circuit having the constitution shown in FIG. 8;

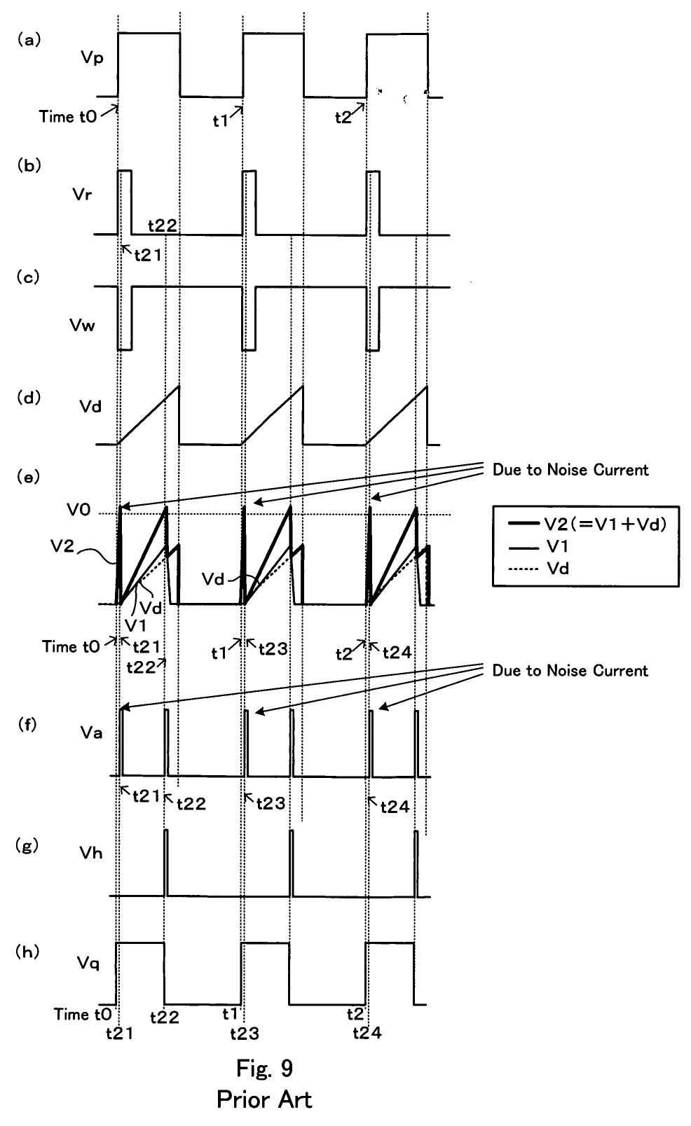

FIG. 10 is an example of a timing chart showing each voltage signal in the switching power supply circuit having the constitution shown in FIG. 8 when the masking function does not work; and

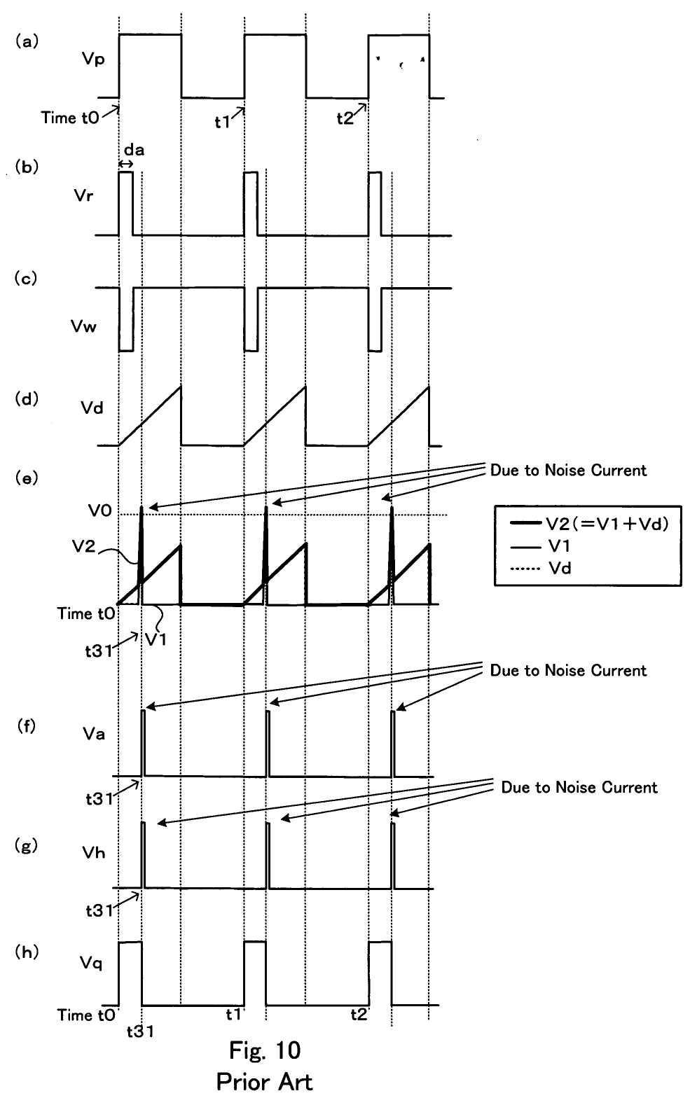

FIG. 11 is an example of a timing chart showing each voltage signal in the switching power supply circuit having the constitution shown in FIG. 8 when a masking function is effective.

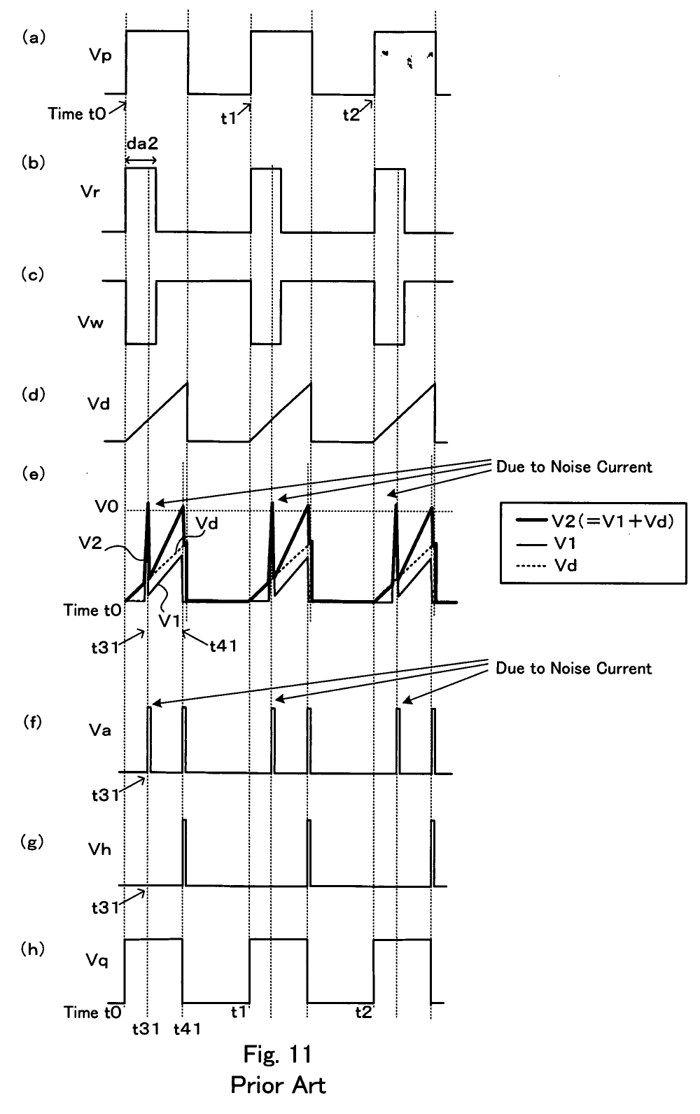

### DETAILED DESCRIPTION OF THE INVENTION

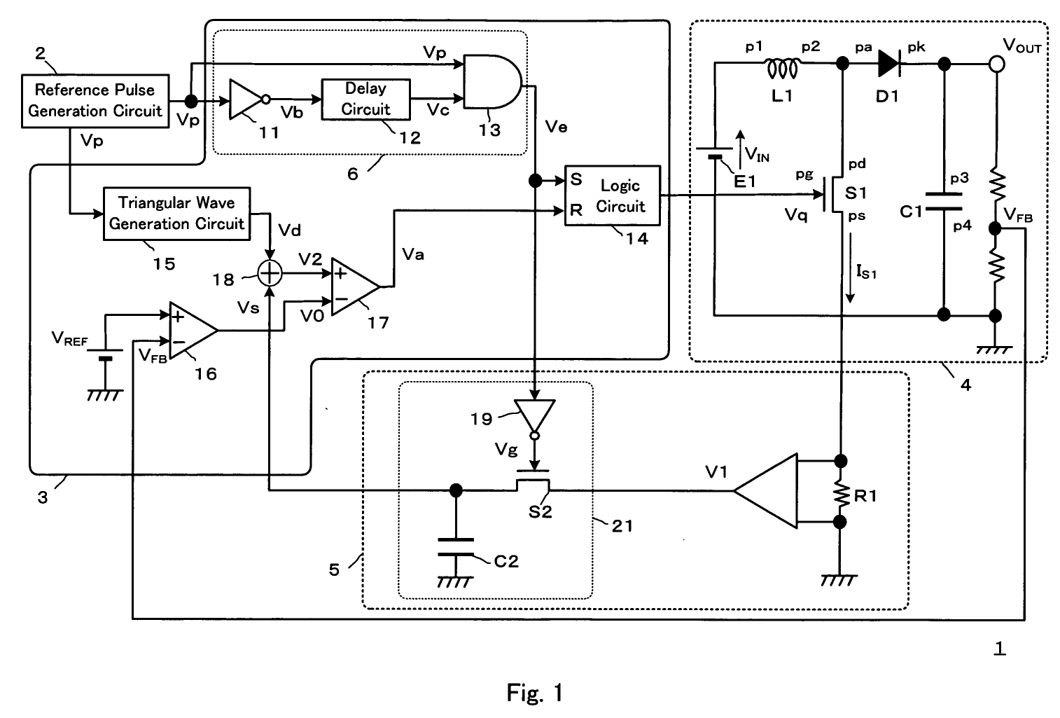

A switching power supply circuit according to the present invention (referred to as the circuit of the present invention occasionally hereinafter) will be described with reference to FIGS. 1 to 4 hereinafter. In addition, the same sign is allotted to the same component as that in the above conventional constitution described in the related art and its description will not be given.

FIG. 1 is a circuit block diagram showing one example of the schematic constitution of the circuit of the present invention. A switching power supply circuit 1 shown in FIG. 1 includes a reference pulse generation circuit 2, a switching control signal generation circuit 3, a DC-DC converter 4, a current detection circuit 5, and a timing signal generation circuit 6. In addition, the switching control signal generation circuit 3 incorporates the timing signal generation circuit 6 in FIG. 1, but not necessarily incorporates the timing signal generation circuit 6, and the timing signal generation circuit 6 may be provided outside the switching control signal generation circuit 3.

The reference pulse generation circuit 2 generates a reference pulse signal having a predetermined period and outputs a reference pulse signal Vp to the timing signal generation circuit 6.

The timing signal generation circuit 6 includes a NOT circuit 11, a delay circuit 12, and an AND circuit 13. The switching control signal generation circuit 3 includes a logic circuit 14, a triangular wave generation circuit 15, a differential amplification circuit 16, a comparison circuit 17, an addition circuit 18 and a DC voltage source V_{REF} other than the circuits that constitute the timing signal generation circuit 6.

When the NOT circuit 11 receives the reference pulse signal Vp, the NOT circuit 11 outputs a negation signal Vb of the reference pulse signal Vp to the delay circuit 12. The delay circuit 12 delays the inputted signal Vb by a predetermined time and inputs a signal Vc to the AND circuit 13. The AND circuit 13 receives the signal Vc from the delay circuit 12 and the reference pulse signal Vp and outputs a signal Ve as the result of AND operation to the logic circuit 14 and the current detection circuit 5 as a timing signal (the signal Ve is referred to as the timing signal occasionally hereinafter). In addition, the logic circuit 14 may be a reset signal priority type of RS flip-flop circuit similar to the above (the logic circuit 14 is referred to as the RS flip-flop circuit 14 occasionally hereinafter). At this time, it is assumed that an output signal Ve of the AND circuit 13 is inputted to a set terminal S of the RS flip-flop circuit 14.

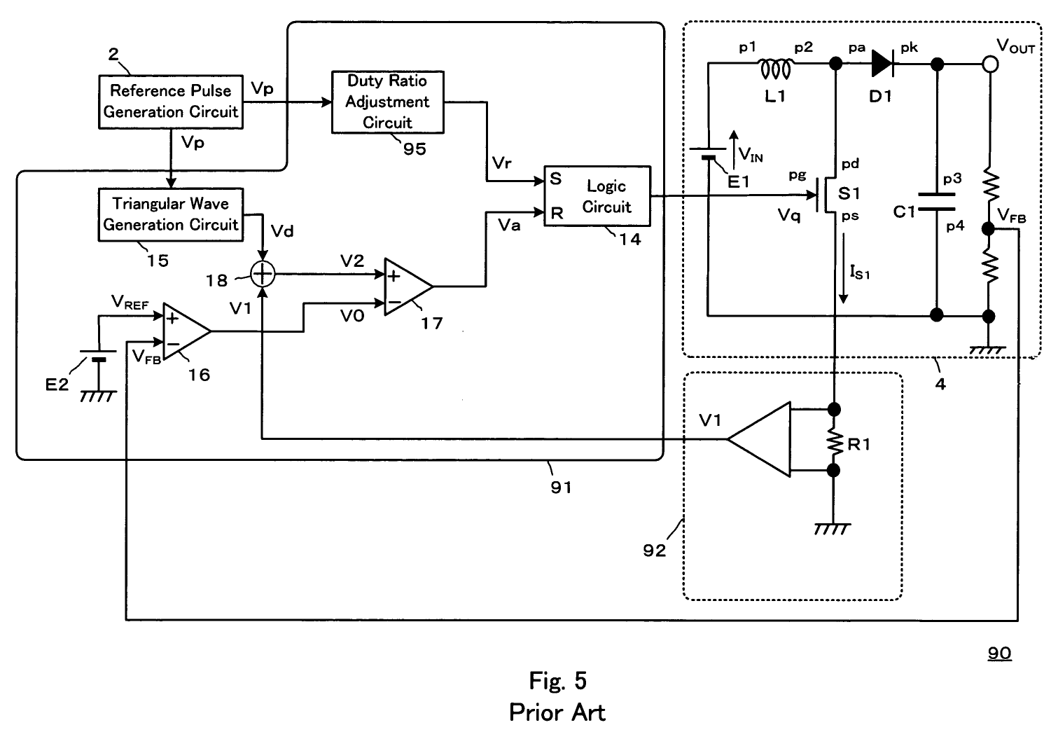

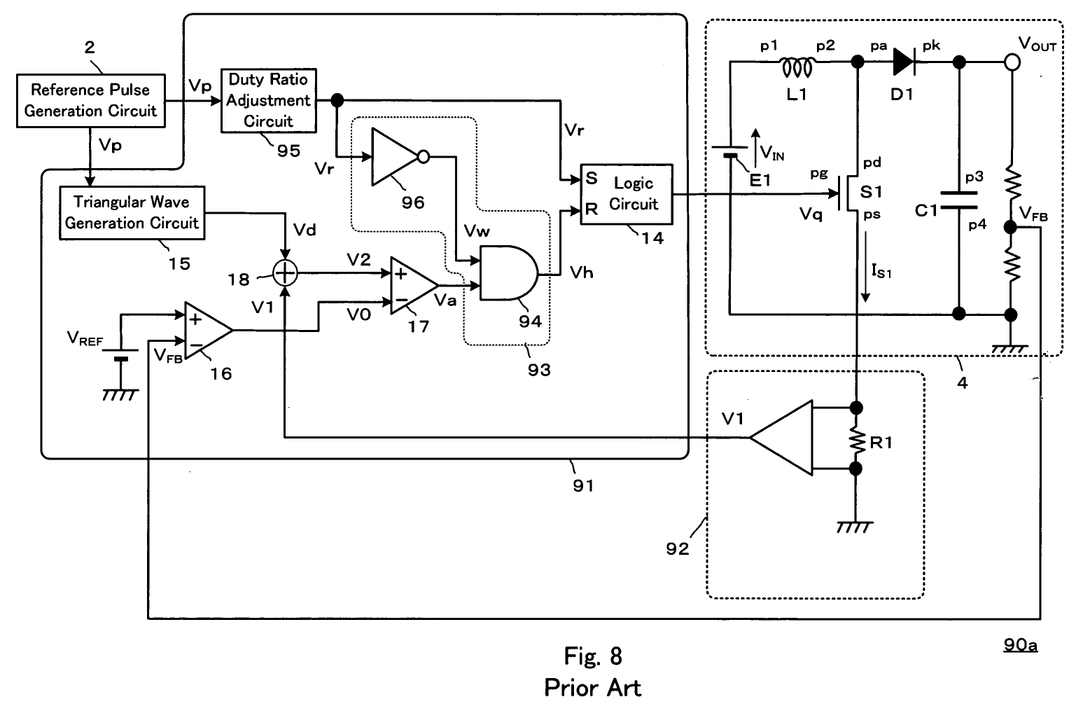

In addition, similar to the constitution in FIGS. 5 and 8, a signal V0 provided by amplifying the voltage difference between the DC voltage V_{REF} set to the predetermined reference voltage value and a feedback input voltage V_{FB}, and an output signal V2 of the addition circuit 18 are inputted to the comparison circuit 17 and the comparison circuit 17 compares them and outputs a signal Va indicating the compared result in binary level, to a reset terminal R of the RS flip-flop circuit 14. Then, the RS flip-flop circuit 14 determines a high level or a low level based on a timing signal Ve at the set terminal and the signal Va at the reset terminal R and outputs a switching control signal Vq. Then, a switching element S1 in the DC-DC converter 4 is controlled to be on or off based on the switching control signal Vq. For example, when the switching element S1 includes an N channel MOSFET, the switching element S1 is in on-state when the switching control signal Vq is at high level and the switching element S1 is in off-state when the switching control signal Vq is at low level.

The current detection circuit 5 further includes a sample hold circuit 21 including a NOT circuit 19, a switching element S2 and a capacitor C2 in addition to the constitution of the above current detection circuit 92. That is, similar to the current detection circuit 92 shown in FIG. 5 or 8, The current detection circuit 5 converts a detection current I_{S1} flowing in the switching element S1 to a voltage value V1 through a resistor R1, and the voltage signal V1 is applied to the switching control signal generation circuit 3 through the sample hold circuit 21.

As described above, the sample hold circuit 21 includes the NOT circuit 19, the switching element S2 and the capacitor C2. The NOT circuit 19 receives the timing signal Ve from the timing signal generation circuit 6 and outputs a converted output signal Vg to the switching element S2. The switching element S2 is controlled to be on or off based on the input of the signal Vg from the NOT circuit 19. When the switching element S2 is in the on-state, the voltage signal V1 is applied to the addition circuit 18 and the voltage V1 is also applied to both ends of the capacitor C2 and charged. Meanwhile, when the switching element S2 is in off-state, the voltage signal V1 is not applied to the addition circuit 18 and the voltage signal charged by the capacitor C2 while the switching element S2 was in on-state is applied to the addition circuit 18. In addition, a description will be made assuming that the voltage signal applied from the current detection circuit 5 to the addition circuit 18 is referred to as a signal Vs and the switching element S2 includes an N channel MOSFET similar to the switching element S1.

The addition circuit 18 combines the signal Vs from the current detection circuit 5 and a signal Vd from the triangular wave generation circuit 15 and applies the output signal V2 to the comparison circuit 17. The comparison circuit 17 compares the output signal V0 from the differential amplification circuit 16 with the output signal V2 from the addition circuit 18 and outputs the signal Va showing the compared result in binary level, to the reset terminal R.

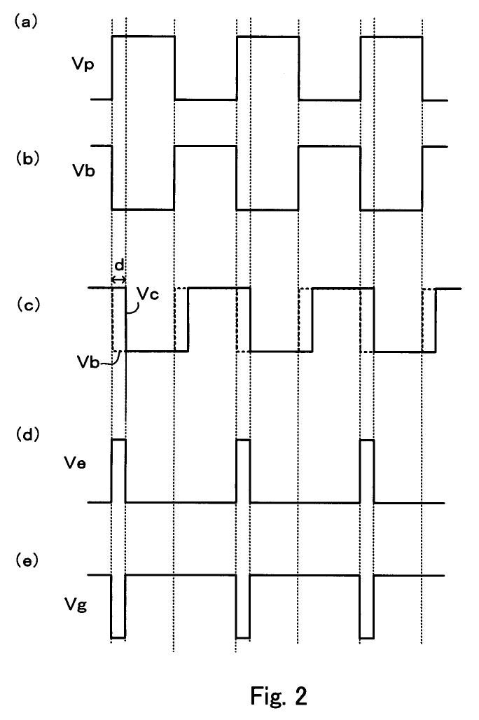

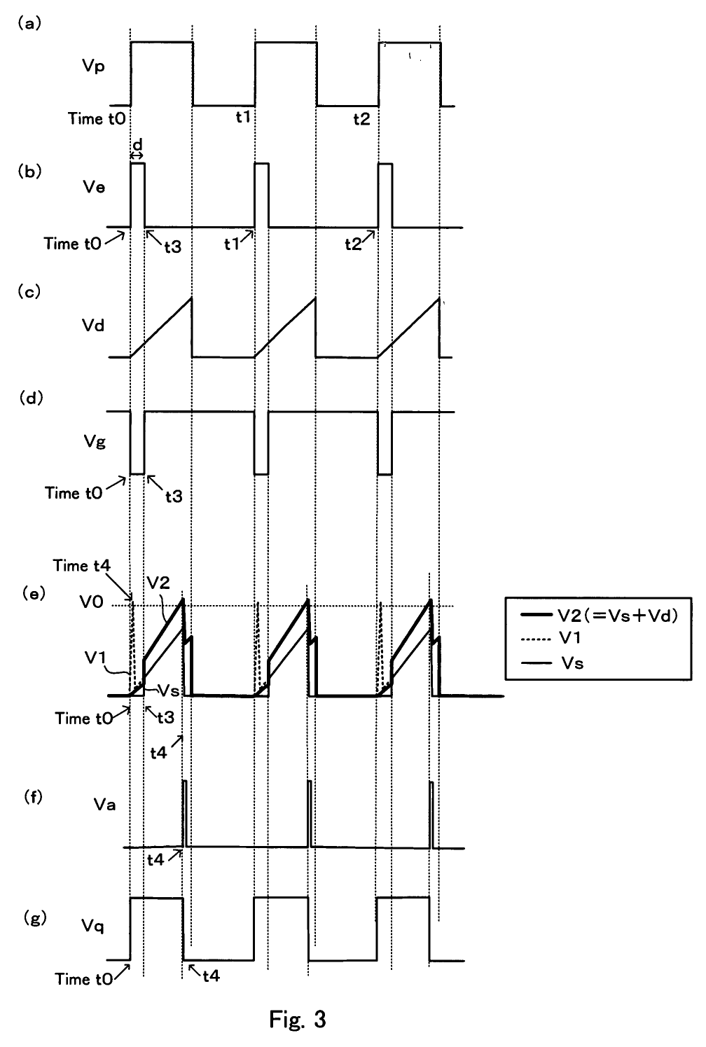

The NOT circuit 19 reverses a polarity of the timing signal Ve inputted to the set terminal S and applies its output signal Vg to the switching element S2. Thus, when the signal Ve inputted to the set terminal S rises from low level to high level, the signal Vg inputted to the switching element S2 falls from the high level to low level. Meanwhile, when the signal Ve inputted to the set terminal S falls from high level to low level, the signal Vg inputted to the switching element S2 rises from low level to high level. The operation of the switching power supply circuit 1 shown in FIG. 1 will be described with reference to timing charts shown in FIGS. 2 and 3.

FIGS. 2 and 3 are timing charts of each voltage signal in the switching power supply 1 circuit having the constitution shown in FIG. 1. In FIG. 2, FIG. 2(a) shows a voltage value of the reference pulse signal Vp, FIG. 2(b) shows a voltage value of the output signal Vb of the NOT circuit 11, FIG. 2(c) shows a voltage value of the output signal Vc of the delay circuit 12, FIG. 2(d) shows a voltage value of the timing signal Ve, and FIG. 2(e) shows a voltage value of the output signal Vg of the NOT circuit 19. In addition, in FIG. 3, FIG. 3(a) shows the voltage value of the reference pulse signal Vp, FIG. 3(b) shows a voltage value of the timing signal Ve, FIG. 3(c) shows a voltage value of a triangular wave output signal Vd, FIG. 3(d) shows a voltage value of the output signal Vg of the NOT circuit 19, FIG. 3(e) shows voltage values of the voltage signal V1 based on the detection current Isi, the output signal Vs of the current detection circuit 5, and the output signal V2 of the addition circuit 18, FIG. 3(f) shows a voltage value of the output signal Va of the comparison circuit 17, and FIG. 3(g) shows a voltage value of the switching control signal Vq. In addition, in FIG. 3(e), a thick solid line shows a voltage value of the signal V2, a thin solid line shows a voltage value of the signal Vs and a thin broken line shows a voltage value of the signal V1.

When the reference pulse signal Vp is outputted from the reference pulse generation circuit 2 as shown in FIG. 2(a), the NOT circuit 11 reverses a polarity of the signal Vp and outputs the reversed signal Vb as shown in FIG. 2(b). The delay circuit 12 delays the signal Vp by a predetermined delay time d and generates the signal Vc (refer to FIG. 2(c)) and the AND circuit 13 outputs the signal Ve as the result of AND operation between the reference pulse signal Vp and the output signal Vc from the delay circuit 12 as a timing signal (refer to FIG. 2(d)). Thus, the NOT circuit 19 reverses a polarity of the signal Ve and outputs the reversed signal Vg as shown in FIG. 2(e).

When the RS flip-flop circuit 14 detects a rise of the signal Ve inputted to the set terminal S at a time t0 (refer to FIG. 3(b)), the switching control signal Vq rises at the same time (refer to FIG. 3(g)), so that the switching element S1 becomes on-state. At this time, as described above, when the switching element S1 is switched from off-state to on-state, a noise current is generated due to the discharge current of the parasitic capacity of the transistor or the recovery current of a parasitic diode in some cases. Thus, it is assumed that the voltage signal V1 that was converted from the noise current to the voltage value by the current detection circuit 5 exceeds the output signal V0 of the differential amplification circuit 16 at a time t4 (refer to FIG. 3(e)). In addition, the variation in value of the signal V1 is shown by the broken line in FIG. 3(e).

Meanwhile, as described above, the signal Vg falls when the signal Ve rises (refer to FIG. 3(d)). As shown in FIG. 3(d), the signal Vg falls at the time t0, keeps low level for a predetermined delay time d set by the delay circuit 12 (it is assumed that the time after the time d is t3 hereinafter), rises at the time t3 and keeps high level until the rise of the signal Ve is detected again. That is, since the signal Vg is at low level from the time t0 to the time t3 and the switching element S2 is controlled based on the level of the signal Vg, while the signal Vg is at low level, the switching element S2 is in off-state.

Therefore, since the switching element S2 is in off-state from the time t0 to the time t3, the signal V1 electrically converted from the detection current I_{S1} to the voltage by the current detection circuit 5 is not applied to the addition circuit 18 through the switching element S2, so that the voltage signal Vs of the voltage charged in the capacitor C2 is applied to the addition signal 18. When the switching element S2 is in on-state, since the same voltage as that of the signal V1 is applied to both ends of the capacitor C2, while the switching element S2 is in off-state from the time t0 to the time t3, the voltage value of the signal V1 when the switching element S2 is in on-state just before the time t0 is applied to the addition circuit 18 from the capacitor C2.

Meanwhile, since the switching element S1 becomes on-state due to the rise of the signal Ve at the time t0, the switching element S1 is in off-state before the time t0 and at this time, the detection current I_{S1} flowing in the switching element S1 is not detected and the voltage V1 detected by the current detection circuit 5 is in an initial state (for example, zero). Therefore, from the time t0 to the time t3, the signal Vs applied from the current detection circuit 5 to the addition circuit 18 is zero regardless of the noise current. That is, the value of the signal V2 shows the voltage value of the triangular wave output signal Vd from the time t0 to the time t3.

Meanwhile, since the signal Vg rises after the time t3, the switching element S2 becomes on-state and the voltage V1 based on the detection current I_{S1} is applied to the addition circuit 18 through the switching element S2 (that is, the voltage value of the signal Vs is the same value as that of the signal V1). At this time, since the noise current have been already generated, the detection current I_{S1} flowing in the switching element S1 and the voltage V1 based on the detection current I_{S1} rise with the time as the current amount flowing in an inductor L1 is increased.

Thus, when the addition signal V2 of the voltage V1 and the triangular wave output signal Vd exceeds the output signal V0 from the differential amplification circuit 16 (refer to FIG. 3(e)), the comparison circuit 17 detects it and raise the signal Va (refer to FIG. 3(f)), whereby a reset is inputted. That is, the switching control signal Vq outputted from the RS flip-flop circuit 14 falls at this time (refer to FIG. 3(g)), so that the switching element S1 becomes off-state. After that, when the set terminal S detects a rise of the reference pulse signal Vp again, the switching control signal Vq rises again and the switching element S1 becomes on-state. Thus, the above switching control is repeated thereafter.

More specifically, according to the constitution of the circuit 1 of the present invention shown in FIG. 1, since the switching element S2 is in off-state from the rise of the reference pulse signal Vp until after the predetermined delay time d, the voltage V0 based on the noise current generated when the switching element S1 switches from off-state to on-state is not applied to the switching control signal generation circuit 3. Furthermore, after the delay time d has passed from the rise of the reference pulse signal Vp, similar to the conventional constitution, the switching element control can be performed in accordance with the voltage V1 based on the detection current I_{S1} flowing in the switching element S1.

According to the circuit 1 of the present invention, since the switching element S1 is controlled without being affected by the current value flowing in the switching element S1 while the output signal Vg of the NOT circuit 19 is at low level, that is, while the timing signal Ve is at high level, the switching control can be implemented without being affected by the current value flowing in the switching element S1 while the noise current could be generated. That is, as compared with the case where the affect by the noise current is prevented by performing the masking process in the switching control signal generation circuit 91 for the detection current during a certain period of time after the switching element has become on-state like the conventional constitution shown in FIG. 8, it is not necessary to consider the time required for the electric signal to reach the circuit for the masking process (the time depends on the wiring length) after the switching element has become on. Therefore, when the delay time d in the delay circuit 12 is set to be longer than a time required for the noise current to flow off after the switching element S1 has switched from off-state to on-state, the affect of the noise current can be surely prevented without receiving the affect of the signal delay in the circuit, so that the malfunction of the switching element S1 can be prevented.

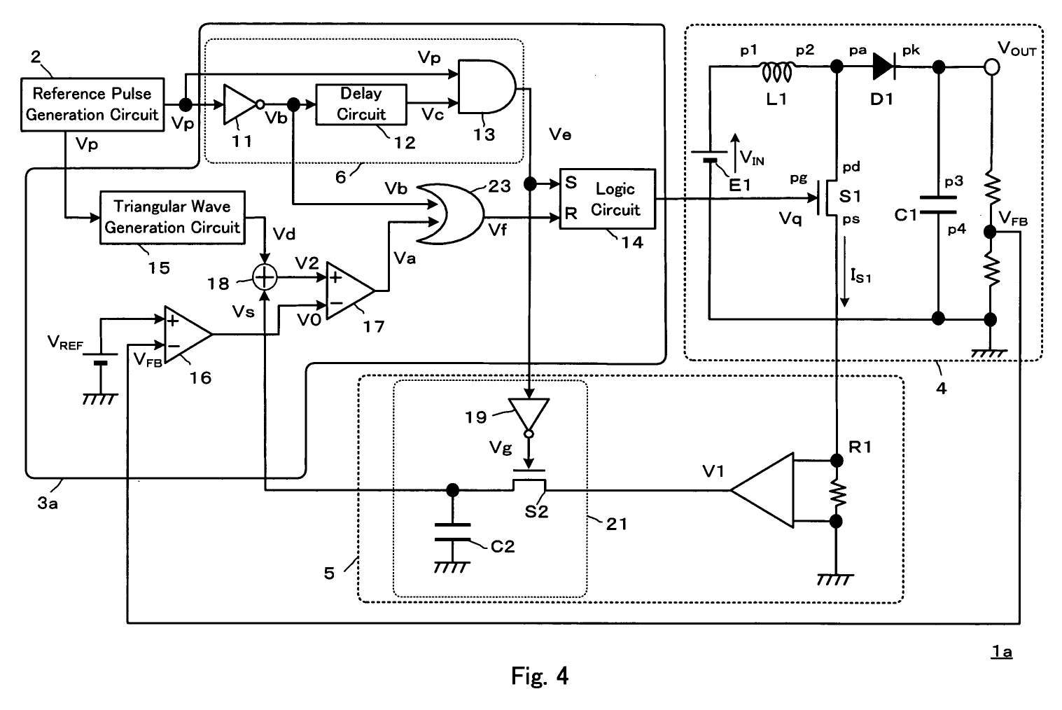

In addition, as another embodiment, the switching control signal generation circuit 3 shown in FIG. 1 may further include an OR circuit (refer to FIG. 4).

A switching control signal generation circuit 3a in a switching power supply circuit 1a shown in FIG. 4 further includes an OR circuit 23 in addition to the switching control signal generation circuit 3 of the switching power supply circuit 1 shown in FIG. 1. The OR circuit 23 receives an output signal Vb of a NOT circuit 11 and an output signal Va of a comparison circuit 17 and outputs a signal Vf based on its OR operation to a reset terminal of a RS flip-flop circuit 14.

In this constitution, even when a voltage V2 does not exceed a voltage V0, since the reset input can be implemented surely due to a rise of the signal Vb, that is, the fall of a reference pulse signal Vp, the reset operation can be forcibly performed without depending on the result of the comparison circuit 17. That is, when the difference between a reference voltage V_{REF} and a feedback input voltage V_{FB} is large and the output signal V0 of a differential amplification circuit 16 shows a sufficiently great value, a signal V2 does not exceed the signal V0 in some cases. However, even in this case, since the reset input can be forcibly performed to the RS flip-flop 14 and the switching element S1 can be switched to off-state, the overcurrent is prevented from flowing in the switching element S1.

In addition, the circuit constitutions described in the above embodiments shown in FIGS. 1 and 4 are only one example and the present invention may be applied to another circuit constitution as long as the circuit constitution has the similar function.

Especially, although the N channel MOSFET is used as the switching element S2 in the above embodiments, a P channel MOSFET can be used. In this case, the sample hold circuit 21 may be so constituted that the timing signal Ve can be directly inputted to the switching element S2 without the NOT circuit 19. That is, the timing signal Ve rises in response to the rise of the reference pulse signal Vp and then the switching element S2 comprising the P channel MOSFET becomes off-state, so that the voltage V1 based on the noise current is not applied to the addition circuit 18 through the switching element S2. In addition, after the delay time d has passed, when the timing signal Ve falls, the switching element S2 becomes on-state, so that the voltage V1 based on the detection current I_{S1} flowing in the switching element S1 is applied to the addition circuit 18. That is, the same effect as that in the above embodiment in which the switching element S2 includes the N channel MOSFET can be provided.

In addition, the signal Ve generated by the timing signal generation circuit 6 can be considered as a signal in which the duty ratio of the reference pulse signal Vp is changed. That is, the timing signal generation circuit 6 can use the duty ratio adjustment circuit 95 in FIGS. 5 and 8, so that the present invention is not limited to the circuit constitution shown in FIG. 1. Thus, as the timing signal generation circuit 6, the duty ratio adjustment circuit 95 having the conventional constitution can be used as it is.

Furthermore, it is not necessary that the signal Ve inputted to the set terminal of the RS flip-flop circuit 14 and the signal Vg inputted to the switching element S2 are completely opposite in polarity but it is only necessary that the rising timing of the signal Ve and the falling timing of the signal Vg are the same. That is, although the period while the signal Ve is at high level after its rising and the period while the Vg is at low level after its falling are not necessarily the same, when they are the same, they can use the common output signal from the delay circuit 12, so that the number of circuits can be reduced.

Although the present invention has been described in terms of the preferred embodiment, it will be appreciated that various modifications and alternations might be made by those skilled in the art without departing from the spirit and scope of the invention. The invention should therefore be measured in terms of the claims which follow.

What is claimed is:

1. A switching power supply circuit for outputting a predetermined DC voltage by controlling on/off of a switching element based on an inputted switching control signal, the switching power supply circuit comprising:
a reference pulse generation circuit for generating a reference pulse signal having a predetermined period;
a current detection circuit for detecting a current flowing in the switching element and outputting an output signal based on a detected detection current value;
a switching control signal generation circuit for generating the switching control signal based on a signal varying depending on the output signal of the current detection circuit and the reference pulse signal; and
a timing signal generation circuit for generating a timing signal, the timing signal switching from a first state to a second state in its signal state in response to a rise of the reference pulse signal and switching from the second state to the first state after the second state is maintained during a predetermined first period, wherein
the current detection circuit receives the timing signal and applies a predetermined output unrelated to the detection current value detected actually during the first period, to the switching control signal generation circuit during the first period.

2. The switching power supply circuit according to claim 1, wherein
the current detection circuit is configured to comprise a sample hold circuit that can hold a signal based on the detection current value temporally, and apply an output signal to the switching control signal generation circuit through the sample hold circuit, and
outputs a signal based on the detection current value to the switching control signal generation circuit during a second period in which the signal state of the timing signal is in the first state, and outputs a held signal based on the detection current value in the second period just before the first period to the switching control signal generation circuit during the first period.

3. The switching power supply circuit according to claim 1, wherein
the switching control signal generation circuit comprises a comparison circuit for comparing a target signal varying depending on the output signal of the current detection circuit with a reference signal inputted from outside and outputting its compared result, and generates the switching control signal which turns on the switching element when the switching element is in off-state at the rise of the reference pulse signal, and turns off the switching element when the comparison circuit outputs the compared result that the target signal exceeds the reference signal.

4. The switching power supply circuit according to claim 3, wherein
the switching control signal generation circuit comprises a logic circuit having two input terminals consisting of a set terminal and a reset terminal and an output terminal for outputting a low level signal from the output terminal regardless of a level of a signal inputted to the set terminal when a signal inputted to the reset terminal is at high level, and outputting a high level signal from the output terminal when the signal inputted to the reset terminal is at low level and the signal inputted to the set terminal is at high level, the logic circuit receiving the reference pulse signal or a pulse signal having the same period as that of the reference pulse signal generated based on the reference pulse signal inputted to the set terminal and a signal based on the compared result inputted to the reset terminal, and outputting the switching control signal from the output terminal.

5. The switching power supply circuit according to claim 4, wherein
the switching control signal generation circuit comprises a NOT circuit for receiving the reference pulse signal, a delay circuit for receiving an output signal of the NOT circuit, and an AND circuit for receiving an output signal of the delay circuit and the reference pulse signal, wherein an output signal of the AND circuit is inputted to the set terminal.

6. The switching power supply circuit according to claim 5, wherein
the switching control signal generation circuit comprises an OR circuit receiving the output signal of the NOT circuit and the signal based on the compared result, wherein an output signal of the OR circuit is inputted to the reset terminal.

7. The switching power supply circuit according to claim 3, wherein
the switching control signal generation circuit comprises a differential amplification circuit for amplifying a difference between a feedback input voltage based on the outputted DC voltage and a target voltage, and a triangular wave generation circuit for generating a triangular wave or a saw wave in synchronization with the reference pulse signal and outputting the triangular wave or the saw wave, wherein
the comparison circuit compares the target signal comprising a combined signal of an output signal of the triangular wave generation circuit and the output signal of the current detection circuit, with the reference signal comprising an output signal of the differential amplification circuit and outputs its compared result.
